(19) United States
(12) Patent Application Publication
(10) Pub. No.: US 2008/0241333 A1
(43) Pub. Date: Oct. 2, 2008

(54) FOAMY COATING OR TOPPING COMPOSITIONS

(76) Inventors: Thomas Cina, Marysville, OH (US); Darryl Barwick, Marysville, OH (US); Keith Roberts, Dublin, OH (US)

Correspondence Address: WINSTON & STRAWN LLP;PATENT DEPARTMENT, 1700 K STREET, N.W., WASHINGTON, DC, 20006, US

(21) Appl. No.: 11/691,578

(22) Filed: Mar. 27, 2007

(51) Int. Cl. A23G 9/00; A23L 1/00

(52) U.S. Cl. 426/565; 426/564

(57) ABSTRACT

The invention relates to a reduced fat foamy coating or topping composition for ice confections or hot or cold beverages. This composition includes a sweetener, a whipping agent, no more than about 10% fat, an emulsifier, a starch and milk or milk derivative, buffering agents, natural or artificial flavorings, and water if necessary. The invention also relates to an ice confection that includes the coating or topping of the invention thereon and the method of making thereof. The invention also relates to a hot or cold beverage having a foamy topping thereon. The invention also relates to a confectionary item having a foamy topping thereon and/or a filling therein. The invention also relates to a culinary product such as soup, sauce or dip that includes these compositions.

### FIELD OF THE INVENTION

The present invention relates generally to compositions for use as aerated ice confection coatings and beverage toppings. In particular, the present invention relates to foamy ice-cream coatings and hot or cold beverage toppings. The present invention can also be used in confection and culinary applications.

### BACKGROUND OF THE INVENTION

Many beverages and desserts are provided with a topping of a different consistency. For ice creams and beverages such as hot chocolate, a whipped cream topping is a typical example of such a topping. While this topping does provide a pleasant organoleptic experience, these type toppings have a relatively high fat content. For example, the foamed beverage toppings disclosed in U.S. Pat. Nos. 5,077,076, 5,462,759, 6,534,108 and 6,713,114 contain about 5 to 15% fat or more. These are not desirable as the industry trend today is toward lower fat containing food stuffs to promote a healthier diet.

Certain desserts also are provided with a coating of an edible material of a different consistency than the dessert. In conventional fat-coated frozen confectionary products, for example, a chocolate based coating is often provided. In these type coatings, the fat is even higher and may account for around 45-60% by weight. In addition to being a health concern, such a high fat content in conventional coatings is also undesirable because 1) it makes the coating brittle and adheres to the ice confectionary core improperly; 2) it results in poor flavor release in the mouth; and 3) it precludes covering water-containing natural food compositions, such as fruit juice, with conventional coatings. Thus, there is a need in the industry to provide coating compositions having a reduced fat content as well as good adhesion to frozen confectionery core, flavor release and heat-shock resistance properties.

There is also a need for improved toppings or coatings that overcome the existing problems of the state of the art. The present invention now addresses these needs by providing low fat coating and topping compositions.

### SUMMARY OF THE INVENTION

The present invention relates to a reduced fat foamy coating or topping comprising a sweetener, a whipping agent, no more than about 10% fat, an emulsifier, a starch and milk or a reconstituted milk derivative. To further reduce the fat content, the milk or milk derivative is, preferably, skim milk.

To enhance stability, the coating or topping composition of the present invention further comprises buffering agents, water soluble organic acids, phosphate, or cream of tartar or combinations thereof, natural or artificial flavorings such as vanilla/vanillin, fruit flavoring, coffee, caramel, chocolate, coconut, green tea, mint, savory flavors and condensed milk, and a proper amount of water for thinning if necessary. Savory flavors are defined as non-sweet flavorings such as, but not limited to, beef, chicken, cheese, onion, pepper, pork, and salt.

The present invention also relates to a frozen novelty comprising the coating of the present invention partially or fully enrobing an ice confection and the method of making such confections. Advantageously, the coating of the present invention has high flexibility and adheres well on the ice confection core to provide good insulation. Furthermore, the coating of the present invention has a wide heat stability range which renders the ice confection resistant to heat shock.

The present invention also relates to hot or cold beverage such as cocoa, coffee, milk, flavored milk, or tea and comprising the composition of the present invention as a foamy topping. This topping can also be provided in confectionary or culinary applications such as on soups or sauces or as a dip.

### DETAILED DESCRIPTION OF THE PREFERRED EMBODIMENTS

The low fat foaming topping or coating of the present invention comprises a sweetener in an amount of between about 2 and 30%. The sweetener advantageously comprises (A), a first component which is sucrose or a sugar substitute such as polyols in an amount of about 5 to 18%, preferably 5 to 15% or an artificial sweetener in an amount that simulates a level of sweetness of sucrose in an amount of about 5 to 18%; and preferably 5 to 15%; and a second component (B), which is corn syrup solids or invert sugar solids in an amount of about 0 to 12%, preferably 5 to 10%. When (B) is present, the ratio of (A): (B) is greater than 1:1, and preferably is between 1:1 to 4:1.

The coating or topping of the present invention further comprises a whipping agent, such as egg or dried egg albumin or other egg white replacer, in an amount of about 0.1 to 0.5%, preferably 0.2 to 0.3%. Egg-albumen is a superior and preferred foam-stabilizing agent. Additional egg white replacers that can be used in the present invention include, but are not limited to, vegetable proteins.

The coating or topping of the present invention further comprises a high melting point fat in an amount of about 1 to 10%, preferably 2 to 5%. The fat in the coating typically comprises 3 to 3.5% of any fats with a melting point that is greater than or equal to 23° C., such as, but not limited to, partially hydrogenated coconut oil, palm kernel oil, and fractionated palm oil. Fats with a melting point of below 20° C. may be added, including lauric cocoa butter substitute or soy lecithin, in an amount of about 0.2 to 0.5%.

Another ingredient of the coating or topping is an emulsifier/stabilizer in an amount of about 0.01 to 5%, preferably 0.05 to 3%. Preferably, the emulsifier/stabilizer comprises about 0.05 to 3% acetylated mono/diglycerides, such as citric acid esters of monoglycerides, or about 0.005 to 0.015% natural gum polysaccharide, such as Xanthan gum, pectin, agar, gellan, carageenan. Also gelatin can be used in an amount of up to 0.5%.

Yet another ingredient of the coating or topping is a starch in an amount of about 0.5 to 5%, preferably 1 to 4%. The starch may be corn starch, wheat starch, rice starch or potato starch. Preferably, the starch is tapioca starch.

The major ingredient of the coating or topping is milk or a reconstituted milk derivative, typically in an amount of about 40 to 85%, and preferably about 60 to 75%. Reconstituted milk derivatives include, but not limited to, buttermilk, skim milk powder, whey, whey protein concentrate, whole milk or powder and yogurt. To further lower the fat content of the coating or topping skim milk, is preferred. In one preferred embodiment of the present invention, the coating comprises 40 to 85% skim milk, 0.5 to 3.0% sodium caseinate, and 0.05 to 0.5% Non Fat Dry Milk (NFDM, low heat). If necessary, the composition can also include water, protein mixes or other liquids suitable for thinning. Needless to say, the total of the ingredients in the composition amount to 100%.

The coating or topping of the present invention further comprises up to about 3.5% water soluble organic acids and buffering agents to enhance stability. In one preferred embodiment of the present invention, the buffering agents comprise 0.1 to 0.25% tetra sodium pyrophosphate, 0.1 to 0.2% cream of tartar, and up to 4% water soluble organic acid(s) including, but not limited to, tartaric acid, citric acid, malic acid, adipic acid and succinic acid. In addition, the acid can also enhance the fruit flavor and prevent the growth of microbes. When present, the most preferred amount of the acid in the coating or topping is about 0.1 to 2%.

The coating or topping of the present invention can be flavored as needed with up to about 20% natural or artificial flavorings including, but not limited to, vanilla/vanillin, fruit flavoring, coffee, caramel, chocolate, coconut, green tea, mint, savory flavors and condensed milk. If necessary, water can be added for thinning.

Preferably, the compositions of the invention are aerated to an overrun of at least 40%, so that they have a density of at least 0.4 to 0.8. The whipping agent assists in enabling these compositions to achieve the desired level of aeration.

The compositions also possess good flexibility, so that they can be coated onto various foodstuffs and hardened at below freezing temperatures without cracking. They also possess good insulation properties to maintain the foodstuff at a lower temperature during consumption in ambient temperatures, with less melting and dripping as a result.

Another embodiment of the present invention is an ice confection that includes one of the compositions described and defined herein, preferably as a foamy coating or topping. The ice confection could be in the form of a portion, a dome, a bar, a morsel, a bonbon, an ice cream cone or a stick bar. The composition can be present as a full or partial coating or as a topping.

The present invention aims at providing the composition as a coating on an ice confection. These coated frozen confectionary products possess the following advantages:
1) a low fat content with high flexibility and good adhesion on frozen confections to make a good insulation for the latter; and
2) good stability with a wide heat stability range so that the coated frozen confections exhibit excellent heat shock stability.

These coatings have sufficient flexibility to conform to the shape of the ice confection core so that there is no cracking and the ice confection core is well insulated. Because of its flexibility, the coating of the present invention holds to the confection core better than other coating such as gels or chocolate/compound coating. For instance, a typical chocolate compound coating will crack or fracture during consumption and allow the melting ice cream to seep through the coating fractures. The present foamy coating invention will provide insulation sufficient to delay the melting of the ice cream, maintain its structure on and around the ice cream and prevent seepage through the coating as the ice cream melts. The aerated stable foam of the present invention is “a low fat milk or reconstituted milk derivative aerated into a water-in-oil emulsion stablised by a protein structure” having a low viscosity such that it is able to dip ice cream bars, enrobe ice cream pieces, layer/swirl in ice cream cups, or receive inclusions. Furthermore, the coating of the present invention has wide heat stability range, which makes the ice confection resistant to heat shock.

Generally, the coating can be applied to completely enrobe the ice confection, but it is also possible to apply an incomplete or partial coating. For other ice confections or desserts, such as those provided in a cup, the composition can be applied as a topping or top coating.

The coating or topping compositions can provide a contrasting color, texture or flavor to the ice confection, dessert or other foodstuffs to which they are applied as a coating, topping or filling. The artisan skilled having this disclosure before them is well aware of how to formulate such contrasting compositions so that no further detail needs to be provided herein.

To make the foamy coating of the present invention, following steps are taken: (1) combining or mixing together the ingredients of the coating including the sweetener, whipping agent, fat, emulsifier, starch, milk or reconstituted milk derivative, buffering agents, natural or artificial flavorings and water if necessary to provide a mixture; (2) pasteurizing the mixture; and (3) aerating the mixture with a high shear to give a final overrun of at least 40% or a density that preferably between 0.4 and 0.8 g/l.

The present invention also relates to a method for producing an ice confection product that comprises forming an ice confection core, forming the foamy coating as aerated stable foam with unique texture similar to that of a mousse, and applying the coating to at least a portion of the ice confection core by dipping, or enrobing, layering or swirling, core filling, molding, drop molding, extruding, spraying or showering.

The present invention also relates to a beverage comprising one of these compositions as a foamy topping described and defined herein. Typical beverages include hot or cold beverages such as cocoa, coffee, milk, flavored milk and tea.

A flavored beverage with the addition of a foamy topping can be prepared with a contrasting flavor or color. This offers the consumer a unique bi-flavor and bi-color beverage experience. Bi-flavor is defined as a two separate and distinct flavors contained in a single system. Bi-color is defined as two separate and distinct colors in a single system. The topping is durable in such applications as it does not coalesce, collapse, dissipate or sink when placed upon a hot liquid (i.e., at a temperature of about 71° C. (or 160° F.)) for at least 20 minutes. This enables the consumer to enjoy the different organoleptic properties of the topping when consuming the beverage as the topping does not significantly dissipate or dissolve during that time period.

### EXAMPLES

The scope of the invention is further described in connection with the following examples which are set forth for purposes of illustration only and are not to be construed as limiting the scope of the invention in any manner.

### Example 1

A reduced fat ice cream coating is prepared with the following composition as set out in Table 1.

TABLE 1

| Ingredient | % |
|---|---|
| Sugars | 20 |
| sucrose | 12 |
| corn syrup solids | 8 |
| Whipping Agents | |
| dried egg albumen | 0.25 |
| Fats | 3.5 |
| partially hydrogenated coconut oil and palm kernel oil | 3 |
| lauric cocoa butter substitute | 0.5 |
| Emulsifiers/stabilizers | 2.3 |
| Monoglycerides and digylcerides | 2.3 |
| Xanthan Gum | 0.01 |
| Starches | 1.1 |
| Tapioca starch | 1.1 |
| Milk or reconstituted Milk Derivatives | 72 |
| skim milk | 70.5 |
| sodium caseinate | 1.5 |
| Acids | 0.5 |
| Malic | 0.25 |
| Tartaric | 0.25 |
| Buffers | 0.3 |
| tetra-sodium pyrophosphate | 0.2 |
| cream of tartar | 0.1 |

### Example 2

### Ice Cream Coating

The ingredients of Example 1 were mixed and the mix is homogenized in an homogenizer system. The homogenized mix experiences a pasteurizing step to a temperature of about 75-85° C. during about 20-50 seconds. The pasteurized component is cooled so as to reach a relatively low temperature of about 4° C. or below. Then, the pasteurized component is allowed to age in refrigerating conditions overnight or a minimum of at least 4 hours prior to the next operation. The low temperature of the aged mix has to be kept at 3-4° C. or below in order to achieve good air incorporation in subsequent operations.

Aeration can then be carried out on the mix in an Aero/Mondo mixer, conventional ice cream freezer or Hobart mixer. An overrun of 40 to 130% can be achieved with each of these mixers. Aeration time span is dependent on the type of mixer used. In particular, the length, configuration and type of dasher, the mix flow rate, capacity, etc., influence the residence time. In the present example, APV Crepaco and Hoyer KF 500 freezers were used for aerating the mix.

The final product included a foamy coating on an ice confection core with good organoleptic properties.

The final product with a foamy coating displays good adhesion on the ice cream bar that it will not separate from the ice cream during heat shock testing (temperature cycling), when biting into the ice cream bar, or as the ice cream bar melts.

The final product with the foamy coating displays good flexibility on the ice cream, it expands and contracts without cracking on the ice cream during temperature and pressure changes.

### Example 3

### Beverage Topping.

The ingredients of Example 1, minus the skim milk for thinning, were mixed and the mix is homogenized as in Example 2. The final product included a foamy topping on a cold or hot beverage such as milk or flavored milk to deliver a durable bi-layer and bi-color experience such as yellow banana foam topping on pink strawberry flavored milk or green mint foam topping on a hot chocolate, where the foam topping expands from the heat of the beverage. In both cases the consumer enjoys two distinct flavors together at consumption.

For example 150 ml of hot water or beverage at 71° C. (160° F.) is placed in a 270 ml clear plastic cup. Then 25 grams of topping is spooned on the hot water or beverage. The topping will float on top of the hot water or beverage without collapse. The foam will spread slightly across the surface and maintain a durable structure for at least 20 minutes.

### Example 4

### Culinary Topping.

The ingredients of Example 1, minus the skim milk for thinning, were mixed and the mix is homogenized as in Example 2. The final product included a durable foamy topping on a hot soup or sauce to deliver a attractive and flavorful experience such as a onion flavored foam topping on a hot soup.

### Example 5

Confectionary Coating and/or Filling.

The ingredients of Example 1, minus the skim milk for thinning, were mixed and the mix is homogenized as in Example 2. The final product included a foamy coating on a cookie/wafer or chocolate bar/piece. The final product may also include a foamy filling between cookie/wafers or coated/enrobed with chocolate.

What is claimed is:

1. A foamy topping or coating composition comprising the following ingredients:
a sweetener in an amount of about 2 to 30% comprising sucrose or a sugar substitute in an amount of about 5 to 18% or an artificial sweetener in an amount that simulates a level of sweetness of sucrose that is in an amount of about 5 to 18%;
a whipping agent in an amount of about 0.1 to 0.5%;
a fat in an amount of about 1 to 10%;
an emulsifier/stabilizer in an amount of about 0.01 to 5%;
a starch in an amount of about 0.5 to 5%; and
milk or a reconstituted milk derivative in an amount of about 40 to 85%;
wherein the ingredient are present in a total amount of 100%.

2. The composition of claim 1 wherein the sweetener further comprises corn syrup solids or invert sugar solids in an amount sufficient to change the viscosity of the composition up to about 12%.

3. The composition of claim 2 wherein the sweetener comprises a first component (A) of sucrose or a sugar substitute in an amount of about 5 to 15% or an artificial sweetener in an amount that simulates the sweetness level of about 5 to 15% sucrose; a second component (B) of the corn syrup solids or invert sugar solids are present in an amount of about 5 to 10%.

4. The composition of claim 1 wherein, the ratio of (A):(B) is between 1:1 to 4:1.

5. The composition of claim 1 wherein the whipping agent is egg, dried egg albumin, an egg white replacer, or a vegetable protein and is present in an amount of about 0.2 to 1.5%.

6. The composition of claim 1 wherein the fat is present in an amount of about 2 to 5%.

7. The composition of claim 1 wherein the emulsifier/stabilizer comprises monogylcerides or diglycerides in an amount of about 0.05 to 3%, a natural gum polysaccharide in an amount of 0.005 to 0.015%, or a gelatin in an amount of about 0.01 to 0.5%.

8. The composition of claim 7, wherein the emulsifier/stabilizer comprises citric acid esters of monoglycerides and is present in an amount of about 0.05 to 3%, or Xanthan gum, pectin, agar, gellan or carageenan gum in an amount of 0.005 to 0.015%.

9. The composition of claim 1 wherein the starch is tapioca starch, corn starch, wheat starch, rice starch or potato starch and is present in an amount of about 1 to 4%.

10. The composition of claim 1 wherein the milk or reconstituted milk derivative comprises skim milk and is present in an amount of about 60 to 75%.

11. The composition of claim 1 further comprising buffering agents, natural or artificial flavorings, and, if necessary, water for thinning.

12. The composition of claim 11, wherein the buffering agent present in an amount of about 0.1 to 3.5% and is an organic acid, phosphate, cream of tartar or combination thereof, and the natural or artificial flavorings, when present, comprises vanilla/vanillin, fruit flavoring, coffee, caramel, chocolate, coconut, green tea, mint, savory flavor and condensed milk or mixtures thereof.

13. An ice confection comprising the composition of claim 1 as a foamy coating upon an ice confection core.

14. The ice confection of claim 13, in the form of a portion, a dome, a bar, a morsel, a bonbon, an ice cream cone or a stick bar with the composition present as a partial or complete coating thereon.

15. The ice confection of claim 13 in the form of a stick bar wherein the foamy coating enrobes the ice confection core to insulate it.

16. The ice confection of claim 13 wherein the coating has a heat stability range which is sufficient to render the ice confection resistant to heat shock.

17. The ice confection of claim 13 wherein the coating has sufficient flexibility to resist cracking when eaten and provides insulation sufficient to prevent the ice confection core from melting and dripping down the stick during consumption over a period of at least 20 minutes.

18. The ice confection of claim 13 wherein the coating provides a contrasting color, flavor or texture to the ice confection core.

19. A beverage or food product that includes a foamy topping comprising the composition of claim 1.

20. The product of claim 19 which is a hot or cold beverage and wherein the topping has an overrun of at least 40% or a density of 0.4 to 0.8.

21. The beverage of claim 20, wherein the beverage has a temperature of about 71° C. (160° F.), and the foam topping maintains a durable structure for at least 20 minutes thereon.

22. The beverage of claim 20, wherein the beverage is cocoa, coffee, milk, flavored milk or tea, and the foam topping provides a beverage with a contrasting color or flavor.

23. A confectionary product that includes a foamy coating or filling comprising the composition of claim 1 and having an overrun of at least 40% or a density of 0.4 to 0.8.

24. A culinary product comprising the composition of claim 1 and having an overrun of at least 40% or a density of 0.4 to 0.8.

25. The culinary product of claim 24 which is a soup, sauce or dip that includes the composition.

26. A method for producing a foamy coating comprising the steps of combining the ingredients of claim 1 to provide a mixture, pasteurizing the mixture and aerating the mixture with high shear to provide an overrun of at least 40% or a density of 0.4 to 0.8.

27. A method for producing the ice confection product of claim 13 which comprises forming an ice confection core, forming the foamy coating as aerated stable foam, and applying the coating to at least a portion of the ice confection core to form the product.

28. The method of claim 27 wherein the coating is applied to the ice confection core by dipping, enrobing, layer/swirl, core filling, molding, drop molding, extruding, spraying or showering.
